(19) United States
(12) Patent Application Publication
(10) Pub. No.: US 2010/0142081 A1
(43) Pub. Date: Jun. 10, 2010

(54) MAGNETIC DISK DEVICE, ACTUATOR ARM, AND SUSPENSION

(75) Inventors: Kei Funabashi, Shanghai (CN); Takuma Kido, Kawasaki (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/630,778

(22) Filed: Dec. 3, 2009

(30) Foreign Application Priority Data
Dec. 4, 2008 (JP) 2008-309968

(51) Int. Cl. G11B 21/02

(52) U.S. Cl. 360/75; G9B/21.003

(57) ABSTRACT

According to one embodiment, a magnetic disk device includes a magnetic disk, a magnetic head, and an actuator. The magnetic disk stores data. The magnetic head floats due to an air flow produced by the rotation of the magnetic disk to write and read data to and from the magnetic disk. The actuator includes a suspension and an actuator arm. The suspension supports the magnetic head. The actuator arm supports the suspension. The actuator is provided with a strip projection, a bump, a plurality of projections, or a concave portion on the upstream side of an air flow produced by the rotation of the magnetic disk.

### CROSS-REFERENCE TO RELATED APPLICATIONS

This application is based upon and claims the benefit of priority from Japanese Patent Application No. 2008-309968, filed Dec. 4, 2008, the entire contents of which are incorporated herein by reference.

### BACKGROUND

1. Field

One embodiment of the invention relates to a magnetic disk device, an actuator arm, and a suspension that reduce turbulence of air flow caused by rotation of a magnetic disk.

2. Description of the Related Art

In a magnetic disk device, data is recorded/reproduced by floating a magnetic head by air flow generated due to the high-speed rotation of a magnetic disk, and positioning the magnetic head to a desired track with an actuator. The actuator has a suspension that supports the magnetic head on one end of the suspension, and an actuator arm that is coupled to the other end thereof and rotates about a support shaft.

As the recording density of a magnetic disk increases, it is necessary to position a magnetic head to a desired track with higher accuracy. In addition, it is required to increase access speed, i.e., speed of writing and reading data to and from the magnetic disk. However, higher rotation of the disk for higher access speed increases turbulence of air flow. The turbulence of air flow causes an actuator arm or a suspension that supports and moves the magnetic head to vibrate. As a result, the positioning accuracy of the magnetic head is largely affected.

Therefore, with respect to the actuator arm or the suspension, there have been proposed conventional technologies for reducing the turbulence of air flow. Reference may be had to, for example, Japanese Patent Application Publication (KOKAI) No. 2002-358743, Japanese Patent Application Publication (KOKAI) No. 2005-78734, and Japanese Patent Application Publication (KOKAI) No. H05-174507.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a magnetic disk device with an actuator arm having a strip projection according to an embodiment of the invention;

FIG. 2 is an exemplary cross-sectional view taken along the line A-A′ in FIG. 1;

FIG. 3 is an exemplary schematic diagram of a comparative example for comparison with the embodiment;

FIG. 4 is an exemplary graph of turbulence of air flow suppressed in the embodiment;

FIG. 5 is an exemplary schematic diagram illustrating an angle formed by the strip projection and the air flow in the embodiment;

FIG. 6 is an exemplary schematic diagram of the magnetic disk device with the actuator arm having another strip projection according to a modification of the embodiment;

FIG. 7 is an exemplary schematic diagram illustrating an angle formed by the strip projection illustrated in FIG. 6 and air flow;

FIG. 8 is an exemplary schematic diagram of the magnetic disk device having a strip projection formed of a single metal plate in the embodiment;

FIG. 9 is an exemplary cross-sectional view taken along the line B-B′ in FIG. 8;

FIG. 10 is an exemplary exploded perspective view of the strip projection illustrated in FIG. 8;

FIG. 11 is an exemplary schematic diagram of the magnetic disk device having another strip projection formed of a single metal plate in the embodiment;

FIG. 12 is an exemplary exploded perspective view of the strip projection illustrated in FIG. 11;

FIG. 13 is an exemplary schematic diagram of the magnetic disk device having a strip projection formed at an end of a single metal plate in the embodiment;

FIG. 14 is an exemplary schematic diagram of the strip projection illustrated in FIG. 13;

FIG. 15 is an exemplary schematic diagram of the magnetic disk device with the actuator arm having a bump as another example in the embodiment;

FIGS. 16A and 16B are exemplary cross-sectional views taken along the line C-C′ in FIG. 15;

FIG. 17 is an exemplary schematic diagram of the magnetic disk device with the actuator arm having another bump as still another example in the embodiment;

FIG. 18A is an exemplary schematic diagram of a strip projection on the actuator arm formed of a different member from the actuator arm in the embodiment;

FIG. 18B is an exemplary cross-sectional view taken along the line D-D′ in FIG. 18A;

FIG. 19A is an exemplary schematic diagram of a bump on the actuator arm formed of a different member from the actuator arm in the embodiment;

FIG. 19B is an exemplary cross-sectional view taken along the line E-E′ in FIG. 19A;

FIG. 20 is an exemplary schematic diagram of an area in which the strip projection and the bump are arranged on the actuator arm in the embodiment;

FIG. 21 is an exemplary schematic diagram of a flexure tail having projections as an example of the embodiment;

FIG. 22 is an exemplary cross-sectional view of the projection illustrated in FIG. 21;

FIG. 23 is an exemplary schematic diagram of a strip projection formed on the flexure on a load beam as an example of the embodiment;

FIG. 24 is an exemplary schematic diagram of a strip projection formed on a damper on the load beam as another example of the embodiment;

FIG. 25 is an exemplary cross-sectional view of the strip projection illustrated in FIG. 24;

FIG. 26 is an exemplary cross-sectional view of a groove used as an alternative to the strip projection illustrated in FIG. 24 in the embodiment;

FIG. 27 is an exemplary schematic diagram of projections formed on the damper in the embodiment; and

FIG. 28 is an exemplary schematic diagram illustrating the operation of the projection on the flexure in the embodiment.

### DETAILED DESCRIPTION

Various embodiments according to the invention will be described hereinafter with reference to the accompanying drawings. In general, according to one embodiment of the invention, a magnetic disk device includes a magnetic disk, a magnetic head, and an actuator. The magnetic disk is configured to store data. The magnetic head is configured to float by the rotation of the magnetic disk to write and read data to and from the magnetic disk. The actuator comprises a suspension and an actuator arm. The suspension is configured to support the magnetic head. The actuator arm is configured to support the suspension. The actuator is provided with a strip projection, a bump, a plurality of projections, or a concave portion on the upstream side of an air flow produced by the rotation of the magnetic disk.

According to another embodiment of the invention, an actuator arm is coupled to a suspension that supports a magnetic head floating from a rotating magnetic disk to write and read data to and from the magnetic disk. The actuator arm comprises a strip projection or a bump on the upstream side of an air flow produced by the rotation of the magnetic disk. The strip projection or the bump is configured to traverse the air flow at an angle equal to or smaller than an angle substantially perpendicular to the air flow.

According to still another embodiment of the invention, a suspension supports a magnetic head floating from a rotating magnetic disk to write and read data to and from the magnetic disk. The suspension comprises a strip projection, a plurality of projections, or a concave portion on an upstream side of an air flow produced by rotation of the magnetic disk. The strip projection or the projections include (s) a surface substantially perpendicular to the air flow on the downstream side of the air flow.

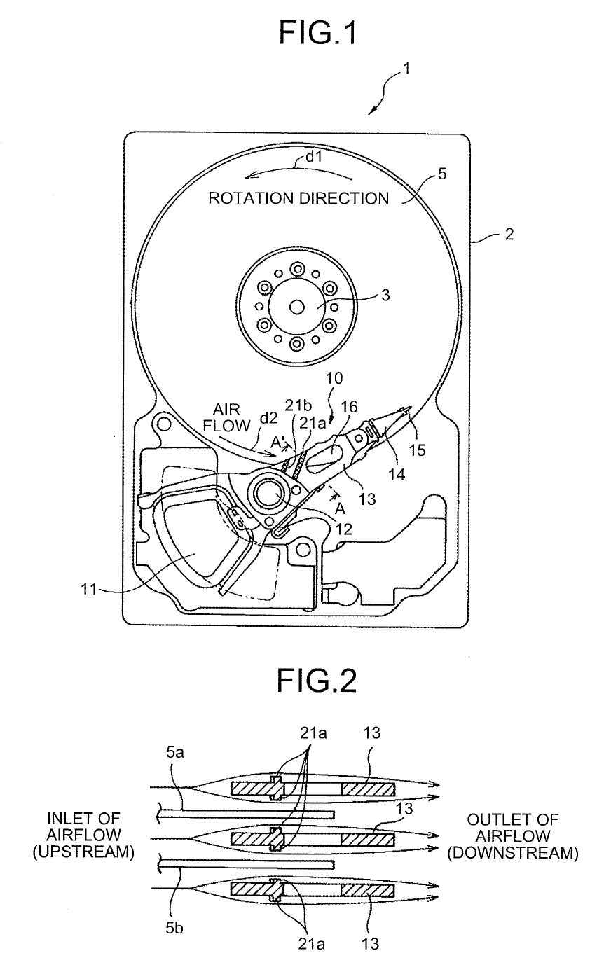

FIG. 1 is a schematic diagram of a magnetic disk device including an actuator according to an embodiment of the invention.

A magnetic disk device 1 comprises at least one magnetic disk 5 rotatable at high speed with a spindle motor 3, and an actuator 10 pivotally and movably supported in the radial direction of the magnetic disk 5, in an enclosure 2. The actuator 10 has an end provided with a magnetic head 15 facing the magnetic disk 5. With the magnetic head 15, data is written to the magnetic disk 5, and the written data is read therefrom.

The magnetic disk device 1 typically has one or more magnetic disks 5 stacked therein, although the apparatus may have one disk. The magnetic disk 5 has a magnetic recording surface on which tracks are concentrically formed and data patterns are written. The data patterns are written to sectors in which the tracks are divided into a predetermined length.

The actuator 10 has a suspension 14 that supports the magnetic head 15, and an actuator arm 13 having a voice coil 11, with the suspension 14 coupled thereto. The actuator arm 13 is formed of, for example, a thick aluminum plate, and supports the suspension 14. Moreover, the actuator arm 13 has an opening 16 to reduce weight.

When one or more magnetic disks 5 are stacked in the magnetic disk device, one or more magnetic heads 15, or the actuator arms 13 are arranged corresponding to the magnetic recording surfaces of the magnetic disks.

The actuator arm 13 is pivotally supported by a support shaft 12. The voice coil 11 causes the actuator arm 13 to rotate about the support shaft 12. The rotation about the support shaft 12 of the actuator arm 13 causes the magnetic head 15 to move in the radial direction of the magnetic disk 5. The magnetic head 15 can be positioned to any track of the magnetic disk 5 by the actuator 10 in response to controlled electric current flowing to the voice coil 11.

The rotation direction of the magnetic disk d1 and the direction of an air flow d2 are illustrated in FIG. 1. The high-speed rotation of the magnetic disk produces air flow in the direction d2 that is the same direction as the rotation direction of the magnetic disk d1. In the embodiment, the actuator arm 13 has two strip projections 21a and 21b. The strip projections 21a and 21b are formed on the air flow inlet side, i.e., the upstream of air flow, on the actuator arm 13, to traverse the air flow produced by the high-speed rotation of the magnetic disk. In FIG. 1, the strip projections 21a and 21b are formed to be substantially perpendicular to the air flow at the respective longitudinal sides. The strip projections 21a and 21b can be formed by fabricating the actuator arm 13 itself during the fabrication of the actuator arm.

FIG. 2 is a cross-sectional view of the actuator arm 13 taken along the line A-A′ in FIG. 1 illustrating the air flow direction and the strip projection 21a formed on the actuator arm 13. As can be seen from FIG. 2, the strip projections 21a and 21b are provided also on the surface of the actuator arm 13 which faces the magnetic disk. However, the strip projections 21a and 21b may be provided only on one side of the actuator arm 13 instead of being provided on both sides thereof. Alternatively, only one strip projection, e.g., the strip projection 21a, may be formed instead of forming the two strip projections 21a and 21b. On the other hand, three or more strip projections may be formed.

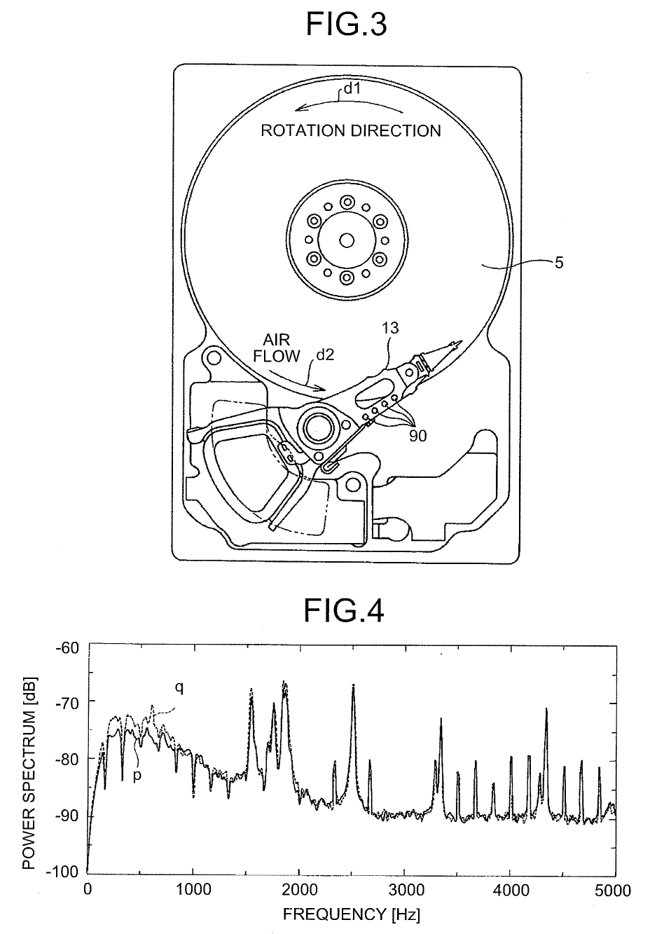

FIG. 3 is a schematic diagram of a comparative example for comparison with the embodiment, in which a plurality of projections 90 are arranged on an area corresponding to the downstream side of the air flow on the actuator arm 13. The projections 90 are provided on both sides of the actuator arm 13. The embodiment and the comparative example have the same structure except for the strip projections 21a and 21b, and the projections 90.

FIG. 4 is a graph of spectra of position error signals from the magnetic heads of the embodiment and the comparative example. In FIG. 4, the horizontal axis indicates frequency, and the vertical axis indicates power spectrum. The solid line and the dashed line indicate the power spectra p and q of the position error signals from the magnetic heads according to the embodiment and the comparative example, respectively.

As can be seen from FIG. 4, the power spectrum p of the embodiment is suppressed to a low level in the frequency band up to 1.5 kilohertz relative to the power spectrum q according to the comparative example. Consequently, with the strip projections 21a and 21b provided on the upstream side of the air flow according to the embodiment, the positioning accuracy improves by 13%. On the other hand, in the comparative example in which the projections 90 are provided on the downstream side of the air flow, the positioning accuracy improves by only about 2%.

FIG. 5 is a schematic diagram illustrating an angle formed by a strip projection 21 and the air flow. In FIG. 1, the strip projection 21 is provided substantially perpendicular to the direction of the air flow when the actuator is positioned on an outer circumference of the magnetic disk. However, as illustrated in FIG. 5, even when the angle α formed by the strip projection 21 and the air flow A is less than 90 degrees, a similar effect to that in FIG. 1 can be obtained. The angle formed by the strip projection 21 and the air flow A is an angle seen from the downstream side of the air flow A, and between the air flow A and the strip projection 21 extending to the head direction, as illustrated in FIG. 5.

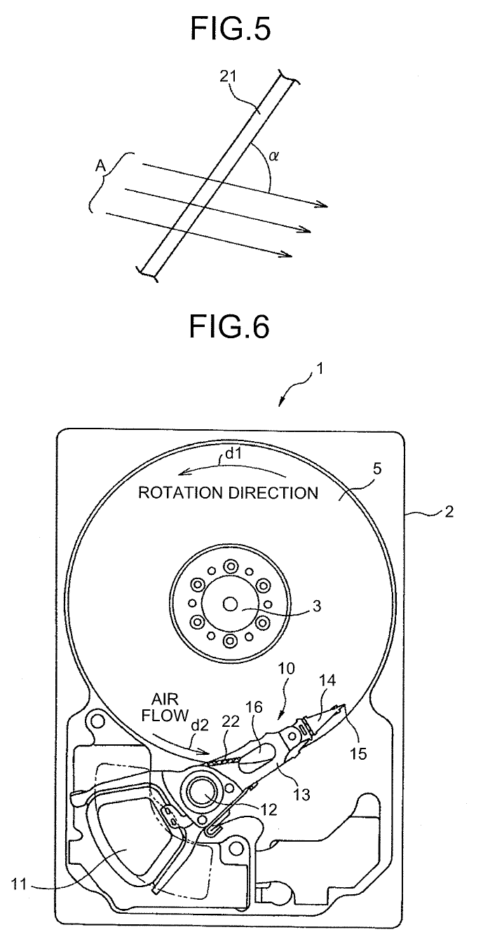

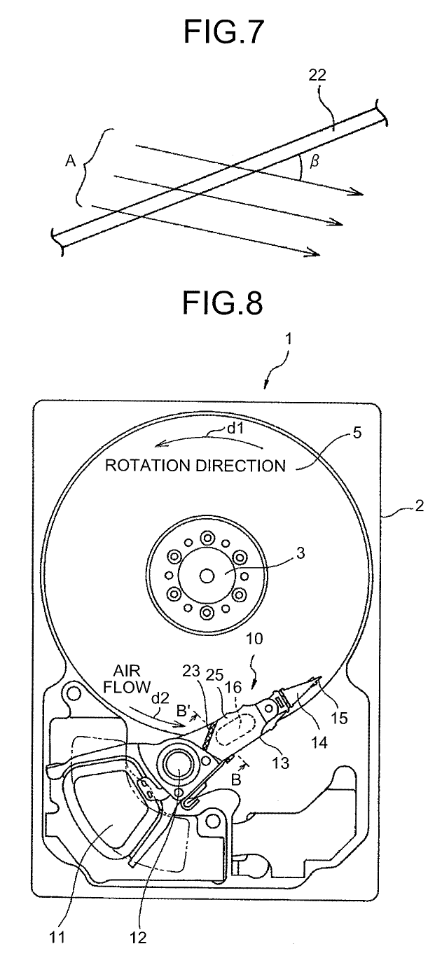

FIG. 6 is a schematic diagram of a modification of the embodiment. In FIG. 6, a strip projection 22 is arranged in place of the strip projections 21a and 21b of the actuator arm 13 in the magnetic disk device illustrated in FIG. 1. When the actuator is positioned on the outer circumference of the magnetic disk, the longitudinal side of the strip projection 22 intersects with the air flow at a small angle. FIG. 7 is a schematic diagram of a positional relationship between the strip projection 22 illustrated in FIG. 6 and the air flow A. The angle β between the strip projection 22 and the air flow A is smaller than 45 degrees. Even when the angle between the strip projection 22 and the air flow A is smaller than 45 degrees, an effect to suppress the turbulence of air flow was obtained.

As is evident, even when the angle between the strip projection and the air flow is small, the turbulence of air flow can be suppressed. However, when the angle between the strip projection and the air flow largely exceeds 90 degrees while the magnetic head moves toward an inner circumference of the magnetic disk, the angle between the strip projection and the air flow is further increased. As a result, the turbulence of air flow might not be suppressed. However, because the turbulence of air flow does not largely affect on the inner circumference of the magnetic disk, an influence of the turbulence of air flow on the inner circumference is ignorable. As a result, an angle formed by the strip projection and the air flow is not particularly limited. When the actuator is positioned on an outer circumference of the magnetic disk, an angle between the strip projection and the air flow can generally be set to about 10 to about 100 degrees.

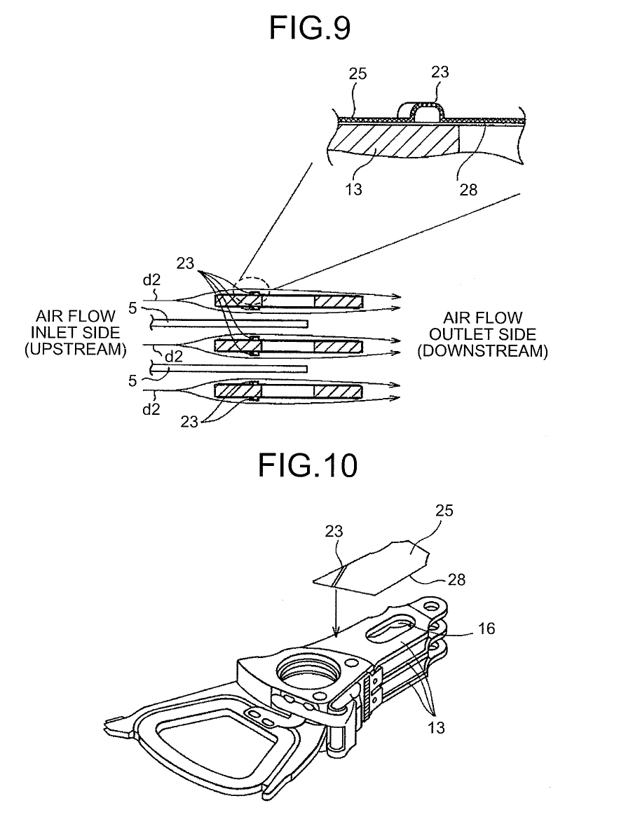

FIG. 8 is a schematic diagram of a strip projection 23 formed of a metal plate 25 on the actuator arm 13. FIG. 9 is a cross-sectional view taken along the line B-B′ in FIG. 8. FIG. 10 is an exploded perspective view illustrating a relation between the actuator arm 13 and the metal plate 25 with the strip projection 23 formed thereon.

In FIG. 8, the metal plate 25 with the strip projection 23 formed thereon is arranged on the actuator arm 13. As illustrated in FIGS. 8 and 9, the metal plate 25 is adhered on the actuator arm 13 with, for example, a viscoelastic material 28 serving as a double-sided tape. The strip projection 23 on the metal plate 25, formed by disposing the metal plate 25 on the actuator arm 13 is arranged on the upstream side of the air flow at a similar angle to that of the strip projection 21a in FIG. 1.

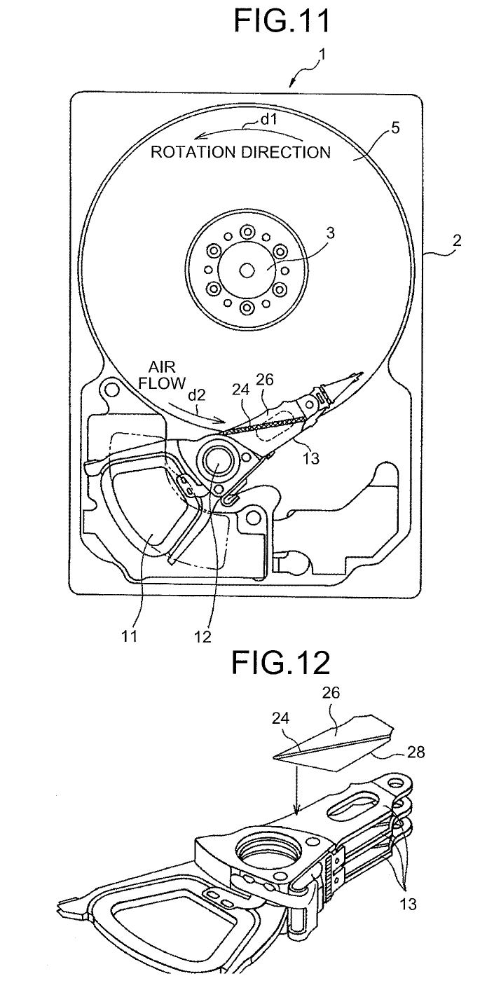

FIG. 11 is a schematic diagram in which another metal plate 26 is used as an alternative to the metal plate 25 illustrated in FIG. 8. FIG. 12 is an exploded perspective illustrating a relation between the metal plate 26 and the actuator arm 13.

A strip projection 24 is formed on the metal plate 26 arranged on the actuator arm 13. The whole metal plate 25 with the strip projection 23 illustrated in FIG. 8 is replaced with the metal plate 26 with the strip projection 24, in the magnetic disk device 1 illustrated in FIG. 11. The angle formed by the strip projection 24 and the air flow d2 in FIG. 11 is smaller than that formed by the strip projection 23 and the air flow d2 in FIG. 8. As illustrated in FIG. 12, the metal plate 26 is adhered on the actuator arm 13 with the viscoelastic material 28. Like the metal plate 25 with the strip projection 23 formed thereon illustrated in FIG. 8, the metal plate 26 with the strip projection 24 formed thereon can suppress the turbulence of air flow.

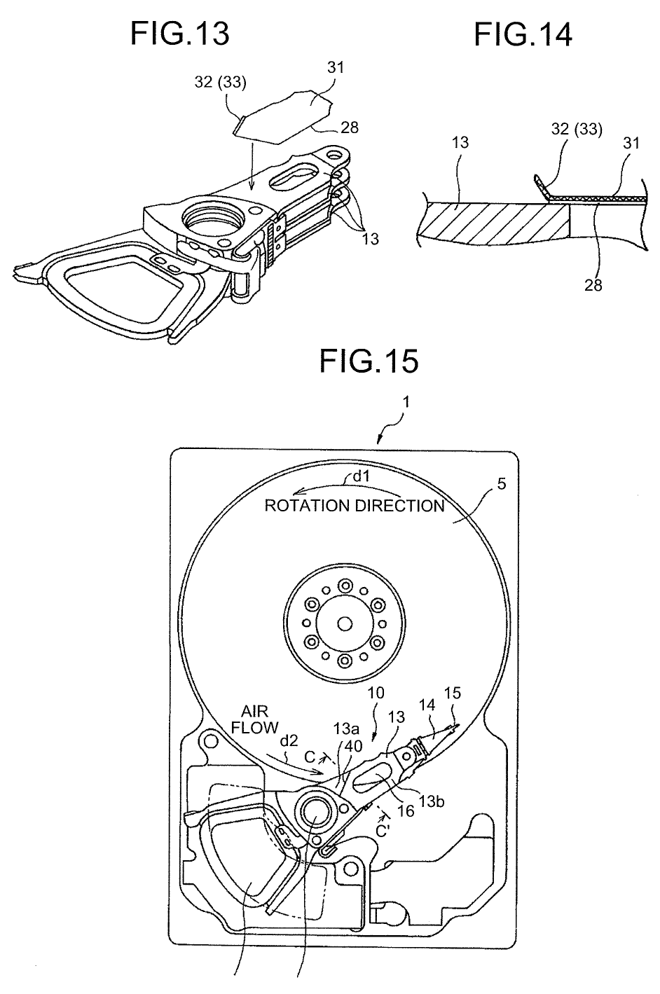

FIG. 13 is a schematic diagram of a metal plate 31 with a folding part that may be used as an alternative to the metal plate 25 with the strip projection 23 illustrated in FIG. 8. FIG. 14 is a cross-sectional view of a folding part 33.

The metal plate 31 has the folding part 33 formed by folding an end 32 of the metal plate 31. In the embodiment, the folding part 33 of the metal plate 31 is used as an alternative to the strip projection 23 of the metal plate 25 illustrated in FIG. 8. The end 32 of the metal plate 31 is formed so as to correspond to a position at which the strip projection 23 of the metal plate 25 is arranged. Accordingly, the folding part 33 with the end 32 of the metal plate 31 folded is formed at which the strip projection 23 illustrated in FIG. 8 is arranged. The metal plate 31 is also adhered on the actuator arm 13 with the viscoelastic material 28. Like the strip projection 23 illustrated in FIG. 8, the folding part 33 can suppress the turbulence of air flow. In addition, the folding part 33 can be formed only by folding the end of the metal plate 31.

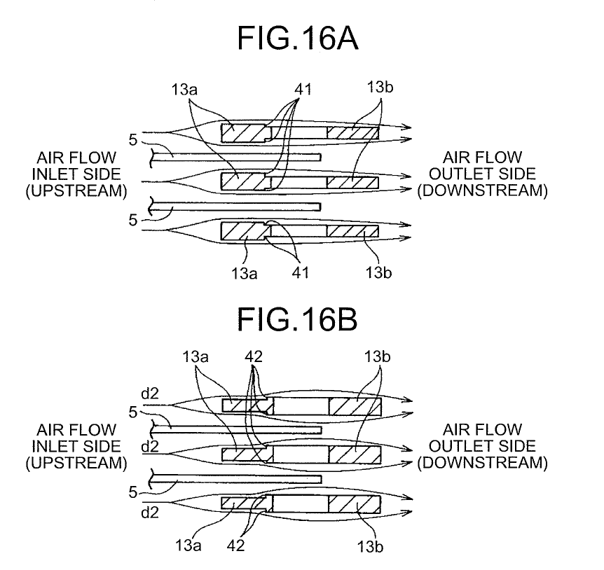

FIG. 15 is a schematic diagram of the actuator arm 13 with a bump 40. FIGS. 16A and 16B are cross-sectional views of bumps 41 and 42 of the actuator arm 13.

The actuator arm 13 in FIG. 15 has an upstream side 13a corresponding to the air flow inlet, and a downstream side 13b corresponding to the air flow outlet. The bump 40 is formed between the upstream side 13a and the downstream side 13b. The bump 40 is arranged at a position corresponding to the strip projection 23 illustrated in FIG. 8.

FIGS. 16A and 16B illustrate a specific example of the bump 40. FIG. 16A illustrates, as an example of the bump 40, the bump 41 in which the upstream side 13a is higher than the downstream side 13b. FIG. 16B illustrates, as another example of the bump 40, the bump 42 in which the upstream side 13a is lower than the downstream side 13b. The bumps 41 and 42 are formed on both sides of the actuator arm 13. Both bumps 41 and 42 suppressed the turbulence of air flow.

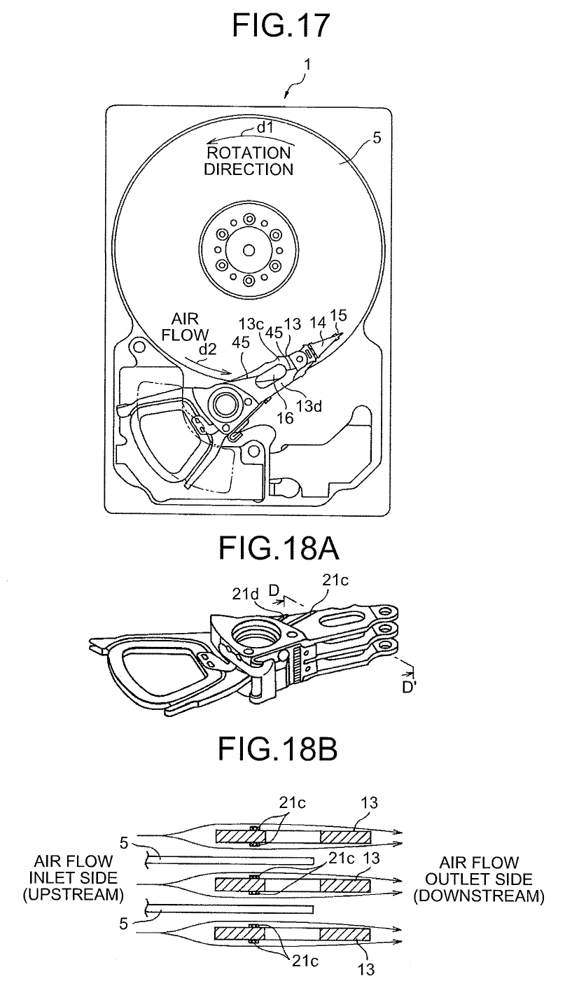

FIG. 17 is a schematic diagram of the actuator arm 13 with another bump 45. The actuator arm 13 in FIG. 17 has an upstream side 13c corresponding to the air flow inlet, and a downstream side 13d corresponding to the air flow outlet. The bump 45 is formed between the upstream side 13c and the downstream side 13d. The bump 45 is arranged at a position corresponding to the strip projection 24 illustrated in FIG. 11.

As with the bump 41 illustrated as a specific example in FIG. 16A, the bump 45 may be a bump in which the upstream side 13c is higher than the downstream side 13d. Further, the bump 45 may be a bump in which the downstream side 13b is higher than the upstream side 13a, as with the bump 42 illustrated as a specific example in FIG. 16B. In addition, the bumps 45 are formed on both sides of the actuator arm 13. The bump 45 suppressed the turbulence of air flow, similarly to the strip projection 24 illustrated in FIG. 11. The bump 45 is formed at which the upstream side 13c or the downstream side 13d abuts on the opening 16 of the actuator arm 13.

FIG. 18A is a view of the strip projection on the actuator arm 13 formed of a different member from the actuator arm 13. FIG. 18B is a cross-sectional view taken along the line D-D′ in FIG. 18A. The strip projections 21a and 21b illustrated in FIG. 1 are formed by fabricating the actuator arm 13 itself. However, the strip projection may be formed of a different member from the actuator arm 13 by securing strips 21c and 21d made of aluminum or stainless steel to the actuator arm 13 with a viscoelastic material. The strips 21c and 21d may be formed into a rectangular cross section to be firmly fixed to the actuator arm 13 with an adhesive. The strips 21c and 21d firmly fixed to the actuator arm 13 can suppress the turbulence of air flow, similarly to the strip projections 21a and 21b illustrated in FIG. 1. The strip projection 22 illustrated in FIG. 6 can similarly be formed to those illustrated in FIGS. 18A and 18B by firmly fixing other strips than the actuator arm 13.

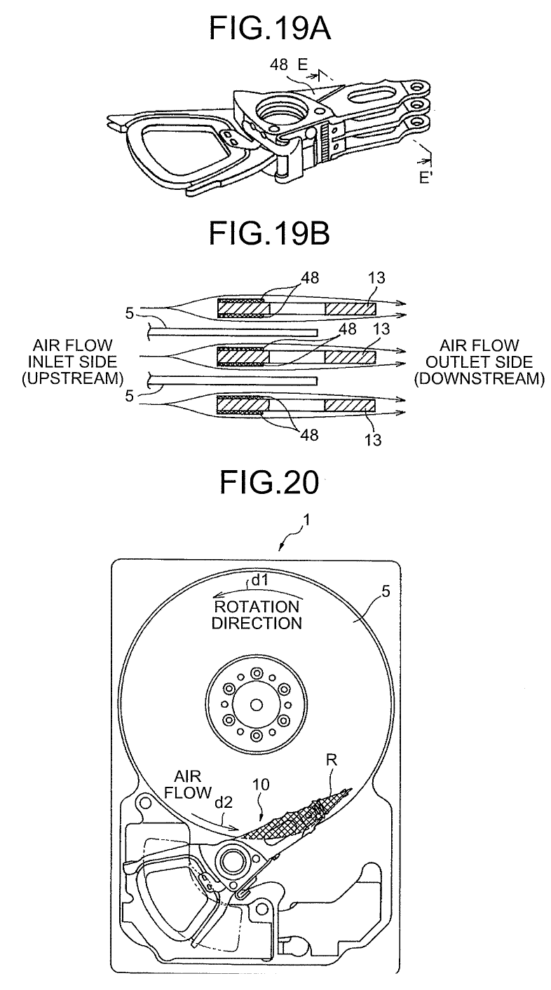

FIG. 19A is a view in which the bump on the actuator arm 13 is formed of a different member from the actuator arm 13. FIG. 19B is a cross-sectional view taken along the line E-E′ in FIG. 19A.

The respective bumps 40 and 45 in FIGS. 15 and 17 are formed by fabricating the actuator arm 13. However, as illustrated in FIGS. 19A and 19B, the bump may be formed by sticking a bump forming plate 48 having an end serving as a bump to the actuator arm 13 without fabricating the actuator arm 13. The bump forming plate 48 is a plate made of aluminum or stainless steel. The bump forming plate 48 secured to the actuator arm 13 with a viscoelastic material can similarly suppress the turbulence of air flow to the respective bumps 40 and 45 in FIGS. 15 and 17. In addition, although the bump forming plate 48 is formed at a position corresponding to the respective upstream sides of FIGS. 15 and 17, a bump forming plate for the respective downstream sides of FIGS. 15 and 17 may also be used.

FIG. 20 is a schematic diagram of an area in which the strip projection and the bump are arranged on the actuator.

The air flows the fastest on and the turbulence of air flow largely affects on the outer circumference of the magnetic disk. Therefore, influence on the turbulence of air flow needs to be suppressed for the actuator when the magnetic head is positioned on the outer circumference of the magnetic disk. In FIG. 20, the actuator 10 has the magnetic head positioned on the outer circumference of the magnetic disk 5. The most effective area for the strip projection or the bump to suppress the turbulence of air flow is an area R that overlaps the magnetic disk and the actuator. Specifically, effective is that the strip projection or the bump is arranged on the actuator within the setting area R, or the upstream side of the air flow so that the strip projection or the bump intersects with the air flow. As can be seen from FIG. 20, the suspension that supports the magnetic head is also within the setting area R. Therefore, the strip projection or the bump may be arranged on the upstream side of the air flow over the suspension so as to intersect with the air flow.

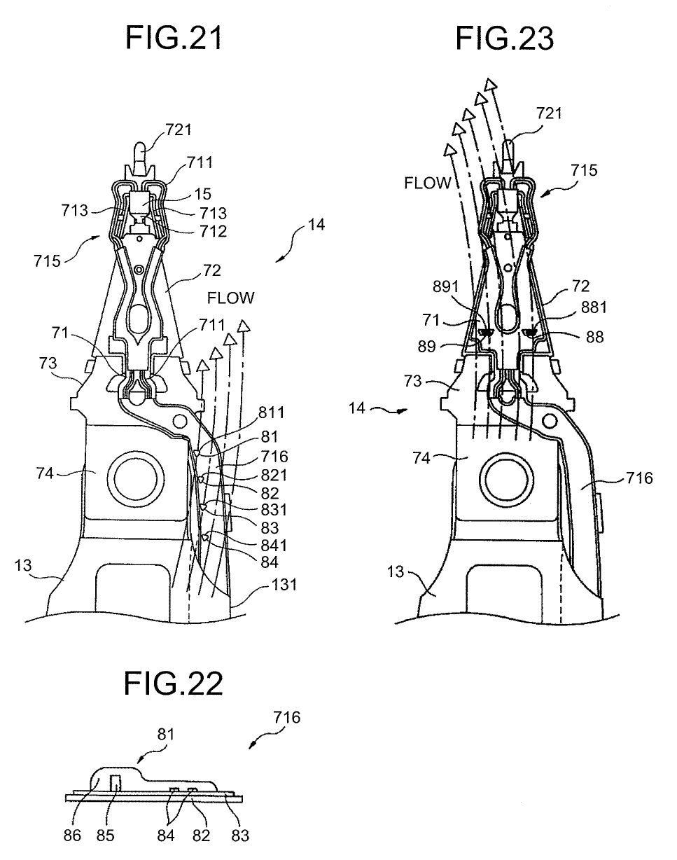

FIG. 21 is a schematic diagram of a surface of the suspension for the magnetic disk facing the magnetic disk. The suspension 14 has a flexure 71, a load beam 72, a hinge plate 73, and a base plate 74.

The flexure 71 has wiring 711 for transmitting read information received by the magnetic head 15 and written information to the magnetic head 15. The flexure 71 has gimbals 715 that support the magnetic head 15, and a flexure tail 716. The gimbals 715 have a tongue 712 that supports the magnetic head 15, and a gimbal arm 713 that supports the tongue 712.

A floating gap of the magnetic head 15 supported by the tongue 712 is equal to or less than 10 nanometers. Consequently, the tongue 712 has a flexible structure in which the magnetic head 15 can withstand vibration and wave of the magnetic disk. The tail 716 passes outside the base plate 74 and is stored in an arm slit 131 formed along the sides of the actuator arm 13.

The load beam 72 is formed as a substantially triangular cantilever spring to support the whole flexure 71. The load beam 72 is relatively robust.

The hinge plate 73 coupled to the load beam 72 is a flexible spring portion to impart spring characteristics in the vertical direction to the load beam 72. A spring portion formed as a part of the load beam 72 may be used as an alternative to the hinge plate 73. Alternatively, the flexure 71 may have a spring portion.

The load beam 72 has a relative end with a partially hemispherical convex portion or a dimple (not illustrated) projected from the load beam 72. The tongue 712 of the gimbals 715 is pressed at the center of the tongue with an end of the dimple, then the center of the magnetic head 15 supported by the tongue 712 is pressed. That is, a spring load is applied to the magnetic head 15 with the dimple of the load beam 72.

The load beam 72 has the extremity with a lift tab 721 formed therewith. The lift tab 721 serves as a guide to a ramp on which the magnetic head 15 retracted from the magnetic disk 5 rests.

In the embodiment, the flexure tail 716 of the flexure 71 has a plurality of projections 81 to 84 arranged at the air flow inlet. The projections 81 to 84 are formed into a substantially triangular prism. Back sides of projections 811 to 841 each of which is aside of the triangular prism and serves as the air flow outlet, are so arranged as to be substantially perpendicular to the air flow. The air flow indicated by the arrows in FIG. 21 becomes a turbulent flow by passing over the back sides of the projections 811 to 841. As a result, a laminar boundary layer becomes a turbulent boundary layer to prevent separation of the boundary layer, thereby reducing the influence of the air flow near the suspension.

FIG. 22 is a cross-sectional view of the projection illustrated in FIG. 21. The tail 716 of the flexure 71 comprises an insulating layer 83 formed of, for example, polyimide, on a support plate 82 formed of, for example, stainless steel. A wiring layer 84 of a conductor such as copper is formed on the insulating layer 83. At the time of forming the wiring layer 84, a dummy pattern 85 is made for forming a projection. A protective layer 86 is formed of, for example, polyimide to protect the wiring layer 84 and the dummy pattern 85. The projection 81 illustrated in FIG. 21 may be fabricated by forming the dummy pattern 85 into a triangular prism and arranging one side of the triangular prism being the air flow outlet to be substantially perpendicular to the air flow.

The projection can be formed when the dummy pattern is made on the formation of the wiring layer, therefore, an extra process to form the projection is eliminated.

FIG. 23 is a schematic diagram of strip projections 88 and 89 formed on the flexure 71 on the load beam 72 . In the embodiment, the width of the flexure 71 arranged on the load beam 72 is wider than the flexure 71 illustrated in FIG. 21. The strip projections 88 and 89 are formed on the flexure 71 arranged on the load beam 72. The strip projections 88 and 89 are arranged at a position corresponding to the air flow inlet of the load beam 72, i.e., near the hinge plate 73. The strip projections 88 and 89 have back sides thereof 881 and 891 being substantially perpendicular to the air flow at the air flow outlet of the strip projections 88 and 89. Therefore, the air flow indicated by the arrows in FIG. 23 becomes a turbulent flow by passing over the back sides of the projections 881 and 891. As a result, a laminar boundary layer becomes a turbulent boundary layer to prevent separation of the boundary layer, thereby reducing the influence of the air flow near the suspension.

The strip projection is manufactured by, during formation of the wiring layer of copper, making a strip dummy pattern corresponding to the strip projection and covering the dummy pattern with a protective layer to form the strip projection, similarly to the projection illustrated in FIG. 21. In the embodiment, the width of the flexure 71 is wide enough to form the wiring layer and the dummy pattern. Only room for the dummy pattern on the flexure 71 on the load beam 72 is needed, so that the shape of the flexure 71 on the load beam 72 is not particularly limited. In addition, one or more strip projections can be formed.

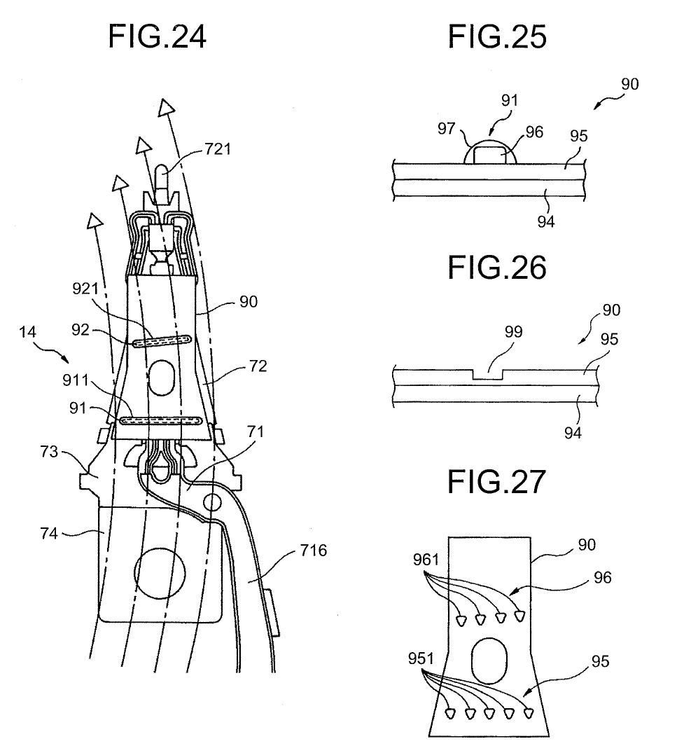

FIG. 24 is a schematic diagram of strip projections 91 and 92 on a damper 90 arranged on the suspension 14. In the embodiment, the damper 90 for damping vibration of the suspension 14 is arranged on the surface of the load beam 72 facing the magnetic disk (a conventional damper is arranged on the opposite side of the surface of the load beam facing the magnetic disk). The damper 90 has the two strip projections 91 and 92 arranged to be perpendicular to the air flow.

FIG. 25 is a cross-sectional view of the strip projection 91 on the damper 90 illustrated in FIG. 24. The damper 90 has a multilayer structure of a viscoelastic layer 94 formed of a viscoelastic material, and a constrained layer 95 formed of, for example, polyimide. Similarly to forming of the flexure, for example, a dummy pattern 96 corresponding to the strip projection 91 is formed on the constrained layer 95 from copper and the like, by an additive method. On the dummy pattern 96, a protective layer 97 made of polyimide is formed.

In the embodiment, the two strip projections 91 and 92 are provided; however, only the strip projection 91 arranged closer to the air flow inlet may be used.

The constrained layer 95 in the damper may be formed of a laminate material made of stainless steel, polyimide, and copper. In addition, the constrained layer 95 may be formed of a laminate material having a sandwich structure, such as stainless steel/polyimide/stainless steel. When the surface of the constrained layer 95 is made of a metal material, the strip projections 91 and 92 can be formed by a subtract method. On the other hand, if the surface of the constrained layer 95 is made of metal, such as stainless steel, the strip projection may be formed by drawing, bending, or etching.

FIG. 26 is a schematic diagram of a groove 99 formed on the damper 90. In FIG. 24, the strip projections 91 and 92 are provided on the damper 90; however, an elongate groove may be formed in place of the strip projection. The surface of the constrained layer 95 on the damper 90 is made of metal, such as stainless steel, a concave portion or the groove 99 may be formed by drawing, bending, or etching. The groove 99 is provided at the air flow inlet on the damper, and substantially perpendicular to the air flow in the longitudinal direction of the groove 99.

When the air flow passes through the groove substantially perpendicular to the air flow, a small vortex is produced in the groove, resulting in turbulent flow. As a result, a laminar boundary layer becomes a turbulent boundary layer to prevent separation of the boundary layer, thereby reducing the influence of the air flow near the suspension. In the embodiment, the groove is not limited to an elongated rectangle, as long as the groove is a concave portion in which the surface of the damper is depressed. The shape of the concave portion may be ellipsoidal, circular, or the like.

FIG. 27 is a schematic diagram of projection lines 95 and 96 made from projections on the damper 90. The strip projections 91 and 92 illustrated in FIG. 24 may be replaced with projections on the damper 90. A shape of the projections is triangular prism having one surface thereof being perpendicular to the air flow at the air flow outlet. In FIG. 26, the projection lines 95 in which a plurality of projections is arranged are used as an alternative to the strip projection 91. In addition, the projection lines 96 in which projections are arranged are used as an alternative to the strip projection 92.

The strip projections 91 and 92 have surfaces 911 and 921 perpendicular to the air flow on the downstream side of the air flow. Similarly, the projection lines 95 and 96 have surfaces 951 and 961 perpendicular to the air flow on the downstream side of the air flow. The air flow passes over the strip projections or the projections to produce a small turbulent flow. As a result, a laminar boundary layer becomes a turbulent boundary layer to prevent separation of the boundary layer, thereby reducing the influence of the air flow near the suspension.

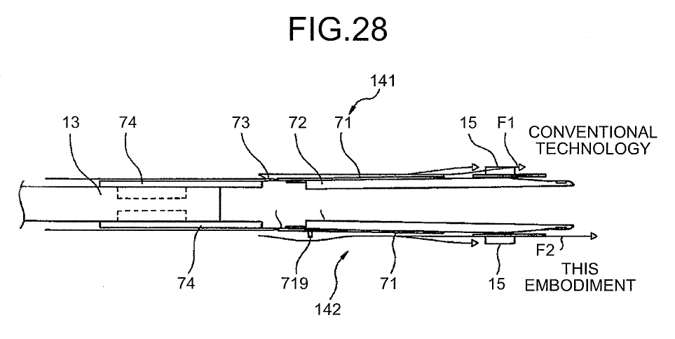

FIG. 28 illustrates the operation when the projection is arranged on the flexure. As illustrated in FIG. 28, the actuator arm 13 has two suspensions 141 and 142 so that the magnetic heads 15 attached to the respective head sliders face the magnetic disk surface. The flexure 71 of one suspension 142 has a projection 719 according to the embodiment. That is, the projection 719 is arranged such that a surface facing the downstream side of the air flow is perpendicular to the air flow. The other suspension 141 is arranged in a conventional manner.

Comparing an air flow F1 with an air flow F2 in FIG. 28, the air flow F1 flowing over the suspension 141 according to the conventional technology is separated from the suspension 141 upstream of the head slider or the magnetic head 15. The separated air flow F1 may have an adverse effect on the magnetic head 15.

On the other hand, the air flow F2 passing over the projection 719 on the suspension 142 flows without separating from the suspension 142. Consequently, the air flow F2 hardly has an adverse effect on the suspension 142.

While an embodiment of the invention, in which a projection, a strip projection, and a concave groove are formed on a suspension, has been described with reference to FIGS. 21 to 28, the position of the projection, the strip projection, and the concave groove is not limited to the embodiment. As illustrated in FIG. 28, the suspension 14 has the flexure 71, the load beam 72, the hinge plate 73, and the base plate 74. Accordingly, the projection, the strip projection, and the concave groove may be arranged at any of the flexure 71, the load beam 72, the hinge plate 73, and the base plate 74.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic disk device comprising:
a magnetic disk configured to store data;
a magnetic head configured to float due to an air flow produced by rotation of the magnetic disk to write and read data to and from the magnetic disk; and
an actuator comprising
a suspension configured to support the magnetic head,
an actuator arm configured to support the suspension, and
either a strip projection, a bump, a plurality of projections, or a concave portion on an upstream side of the air flow.

2. The magnetic disk device of claim 1, wherein the actuator arm comprises either the strip projection or the bump configured to traverse the air flow at an angle equal to or smaller than an angle substantially perpendicular to the air flow.

3. The magnetic disk device of claim 2, wherein the strip projection is formed on a thin metal plate attached to the actuator arm.

4. The magnetic disk device of claim 2, wherein the strip projection is a folded end of a thin metal plate attached to the actuator arm.

5. The magnetic disk device of claim 2, wherein the strip projection and the bump are a separate portion from the actuator arm attached to the actuator arm.

6. The magnetic disk device of claim 1, wherein the suspension comprises the strip projection or the projections comprising a surface substantially perpendicular to the air flow on a downstream side of the air flow, or the concave portion.

7. The magnetic disk device of claim 6, wherein
the suspension comprises a flexure comprising a wiring layer, and
the flexure comprises the strip projection or the projections.

8. The magnetic disk device of claim 1, wherein
the suspension comprises a damper comprising a viscoelastic layer and a constrained layer, and
the constrained layer comprises the strip projection, the projections, or the concave portion.

9. An actuator arm coupled to a suspension configured to support a magnetic head floating from a rotating magnetic disk to write and read data to and from the magnetic disk, the actuator arm comprising:
a strip projection or a bump on an upstream side of an air flow produced by rotation of the magnetic disk, the strip projection or the bump configured to traverse the air flow at an angle equal to or smaller than an angle substantially perpendicular to the air flow.

10. The actuator arm of claim 9, wherein the angle is substantially perpendicular to the air flow.

11. The actuator arm of claim 9, wherein the strip projection is formed on a thin metal plate attached to the actuator arm.

12. The actuator arm of claim 9, wherein the strip projection is configured a folded end of a thin metal plate attached to the actuator arm.

13. The actuator arm of claim 9, wherein the strip projection and the bump are a separate portion from the actuator arm attached to the actuator arm.

14. A suspension configured to support a magnetic head floating from a rotating magnetic disk to write and read data to and from the magnetic disk, the suspension comprising:
a strip projection, a plurality of projections, or a concave portion on an upstream side of an air flow produced by rotation of the magnetic disk, the strip projection or the projections comprising a surface substantially perpendicular to the air flow on a downstream side of the air flow.

15. The suspension of claim 14, further comprising a flexure comprising a wiring layer, wherein
the flexure comprises the strip projection or the projections.

16. The suspension of claim 14, further comprising a damper comprising a viscoelastic layer and a constrained layer, wherein
the constrained layer comprises the strip projection, the projections, or the concave portion.

17. The suspension of claim 14, wherein the projections are configured to be in a substantially triangular prism shape.

18. The suspension of claim 14, wherein the strip projection and the projections are deposited patterns.
